(19) United States
(12) Patent Application Publication
(10) Pub. No.: US 2009/0115094 A1
(43) Pub. Date: May 7, 2009

(54) METHODS FOR MAKING CONTINUOUS NANOCHANNELS

(76) Inventors: Stephen Y. Chou, Princeton, NJ (US); Xiaogan Liang, Princeton, NJ (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/129,418

(22) Filed: May 29, 2008

Related U.S. Application Data
(60) Provisional application No. 60/940,613, filed on May 29, 2007.

(51) Int. Cl. B29C 33/42

(52) U.S. Cl. 264/219; 264/299; 425/112; 977/888

(57) ABSTRACT

This application describes a novel method of fabricating narrow (2-100 nm) width and long (greater than 50 micrometers and preferably 1 centimeter or longer) yet continuous hollow channels that allow flow of fluid or gas, or their combination. It can optimally include RIE pattern transfer or an optional sealing of a top surface over the channel. The invention also includes a novel method for making an imprint mold for imprinting the channel.

### CROSS-REFERENCE TO RELATED APPLICATIONS

This application claims benefit of U.S. Provisional Application Ser. No. 60/940,613 filed May 29, 2007 and is incorporated herein by reference.

### STATEMENT REGARDING FEDERALLY SPONSORED RESEARCH

This invention was made with government support under contract awarded by DARPA. The government has certain rights in this invention.

### BACKGROUND OF THE INVENTION

In many fields such as biology, nanofluidics, optics, electronics, magnetic data storage, sensing, actuating and others, there is a great need for long hollow channels of a width or diameter in the sub-100 nm range that are continuous for a liquid or a gas to flow over the entire channel. For example, in the biological analysis of DNA and other biomaterials, there is a great need for a long channel having width less than 10 nanometers.

However, the current technology is incapable of creating such nano-width, long-length yet continuous hollow channels. For example, all optical lithographies and most etching technologies will create edge roughness, which will clog the channel (making the channel effectively discontinuous) as the channel width gets smaller. For sub-50 nm width or diameter channels, current photolithography does not have the needed patterning resolution. Electron-beam lithography (EBL) may have the needed resolution, but it has several drawbacks that prevent it from making these narrow and continuous channels. First is noise in EBL that makes pattern edge roughness that can clog the channel. Second, the typical scan writing field of EBL is only about 100 microns. It is difficult to write a nanochannel longer than the writing field (stitching of writing fields is very difficult and will make the channel discontinuous); and third, EBL is very slow and expensive. Furthermore, conventional etching used with conventional lithographies such as reactive ion etching (RIE), will introduce additional edge roughness which can clog a nano-width hollow channel.

Accordingly, there is a need for a technology for long, sub-100 nm wide continuous hollow channels, which can pass liquid or gas or their combinations.

### BRIEF SUMMARY OF THE INVENTION

This application describes a novel method of fabricating narrow (2-100 nm) width and long (greater than 50 micrometers and preferably 1 centimeter or longer) yet continuous hollow channels that allow flow of fluid or gas, or their combination. It can optimally include RIE pattern transfer or an optional sealing of a top surface over the channel. The invention also includes a novel method for making an imprint mold for imprinting the channel.

### BRIEF DESCRIPTION OF THE SEVERAL VIEWS OF THE DRAWINGS

FIG. 1 is a flow diagram showing steps in the fabrication of hollow continuous channels with uniform nanoscale (width or diameter) over a long channel length.

FIG. 2 schematically illustrates steps in the fabrication of hollow continuous channels with uniform nanoscale width or diameter over a long channel length.

FIG. 3 is a flow diagram showing steps in the fabrication of a mold for making the hollow continuous channels with uniform nanoscale width or diameter over a long channel length.

FIG. 4 schematically illustrates steps in the fabrication of a mold for imprinting hollow continuous channels with uniform nanoscale width or diameter over a long channel length.

FIG. 5 is a scanning electron micrograph (SEM) image of a SiO2 (silicon-dioxide) etching mask and an anisotropically etched (110) silicon with an edge aligned to a<111> plane. It shows that despite of the edge roughness in the SiO2 mask, the anisotropically <111> Si plane is smooth.

FIG. 6 is a scanning electron microscopy (SEM) image of a mold made by the process described in FIGS. 3 and 4. The mold has a 17 nm wide, 1.5 centimeter long single channel pattern protrusion.

FIG. 7 is a scanning electron microscopy (SEM) image of a mold having a 17 nm wide channel and the channel imprinted in a material by the mold. The mold was fabricated using the methods of FIGS. 3 and 4. The SEM shows that even though there are variations on the sidewall, the fabrication method still creates a continuous and uniform channel.

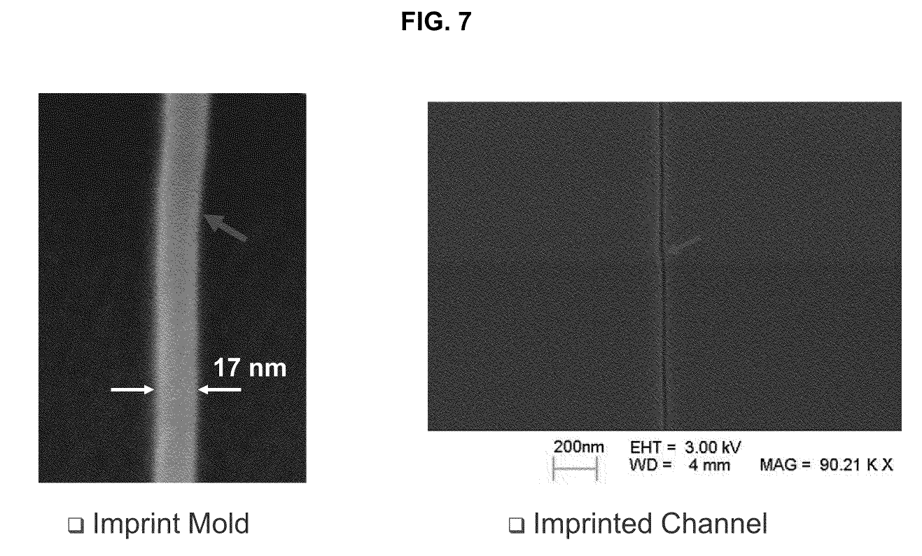

FIG. 8 is a scanning electron microscopy (SEM) image of different sections of a mold with a 17 nm wide channel of 1.5 centimeter length. The mold is fabricated using the methods of FIGS. 3 and 4. The channel width has an error of 1.6 nm (3σ) over the 1.5 centimeter channel length.

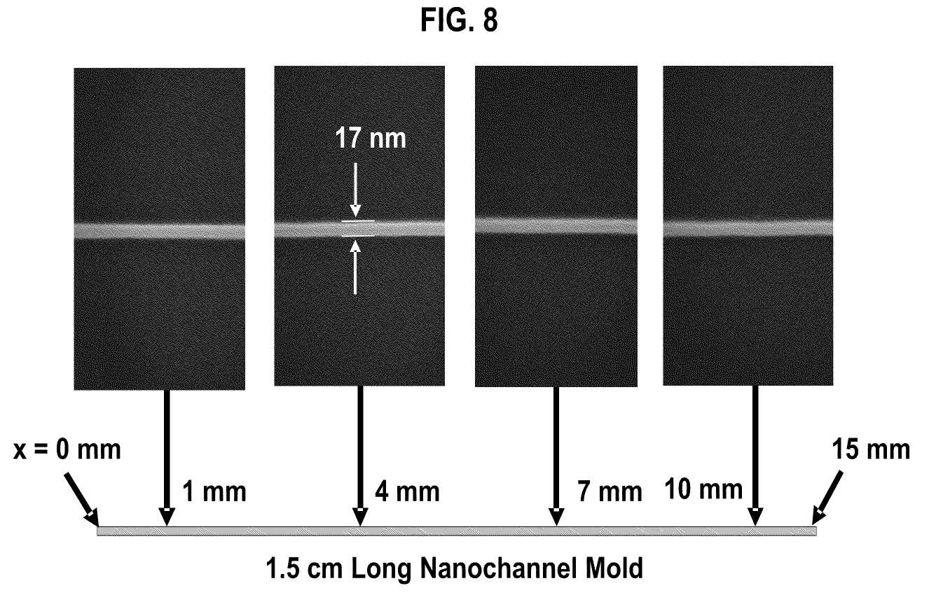

FIG. 9 is a scanning electron microscopy (SEM) image of a 17 nm wide channel of 1.5 centimeter length imprinted in a material by the mold of FIG. 8. The imprinted channel width over the 1.5 centimeter channel length has an error of 3 nm (3σ).

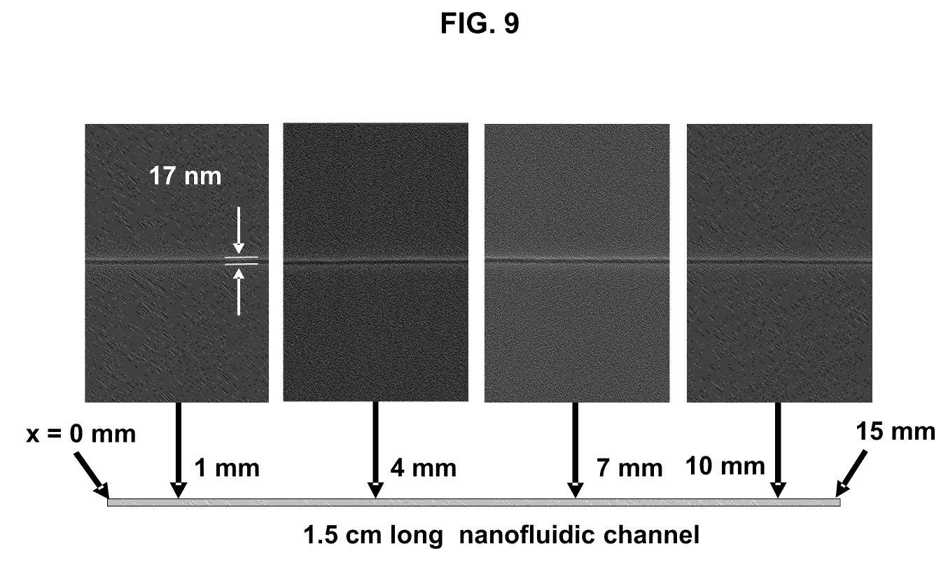

FIG. 10 is a scanning electron microscopy (SEM) image of a 18 nm wide channel of 1.5 centimeter length etched in SiO2 using the imprinted material of FIG. 9 as an etching mask. The imprinted channel width over the 1.5 centimeter channel length has an error of 6 nm (3σ).

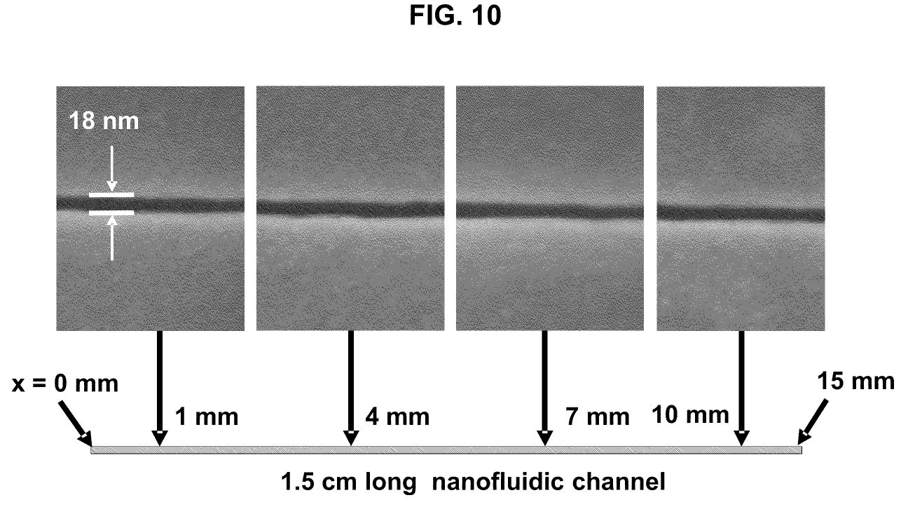

FIG. 11 is a scanning electron microscopy (SEM) image of a mold for imprinting an 11 nm wide channel of 1.5 centimeter length fabricated in SiO2.

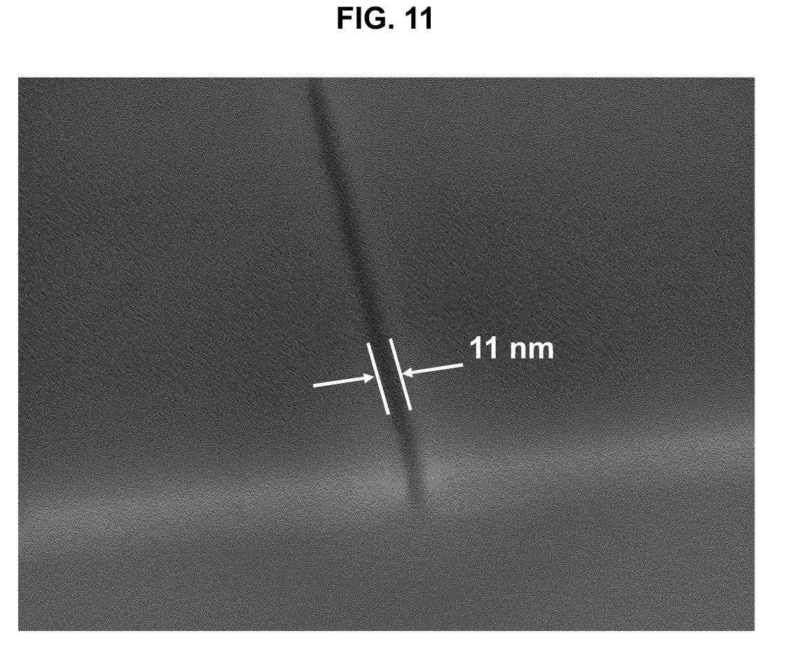

FIG. 12 demonstrates continuous flow through a 30 nm wide, 8 mm long, enclosed (with top cover sealed) channel. This is an optical microscopy image. The green color is a fluorescent liquid.

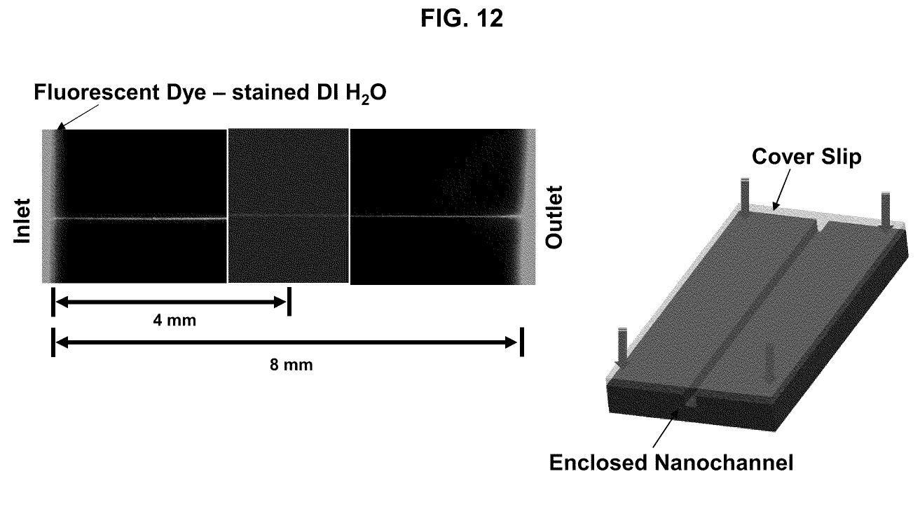

FIG. 13 demonstrates a stretched T2 DNA strand moving through a 3 mm long, 50 nm square nanochannel. This is an optical microscopy image. The DNA includes a fluorescent dye.

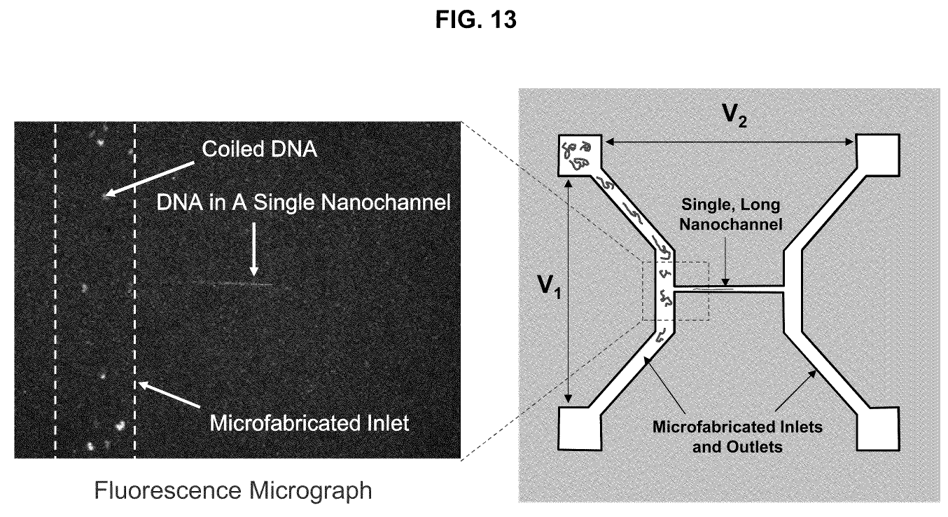

### DETAILED DESCRIPTION

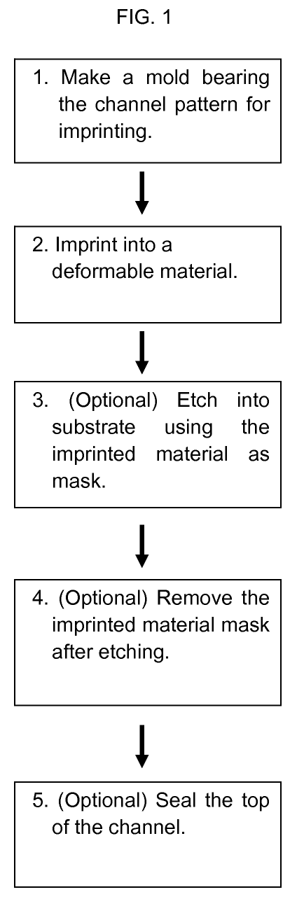

Our invention is a method for fabricating narrow (2-100 nm) width and long (50 micrometers or more and preferably one centimeter or longer) yet continuous hollow channels that allow flow of liquid or gas, or their combination. The method comprises two basic steps and three optional steps, as illustrated in FIG. 1. The first basic step is to provide a nanoimprint mold which has a nanochannel pattern for imprinting a channel that is narrow, long and continuous. The second basic step uses nanoimprint lithography to imprint the mold pattern into a deformable material. Optionally, the imprinted pattern can be used as an etching mask to transfer the channel into a substrate, and the etching mask can stay or be removed. As another option, regardless of any etching used or not, the top surface of the channel fabricated can be sealed.

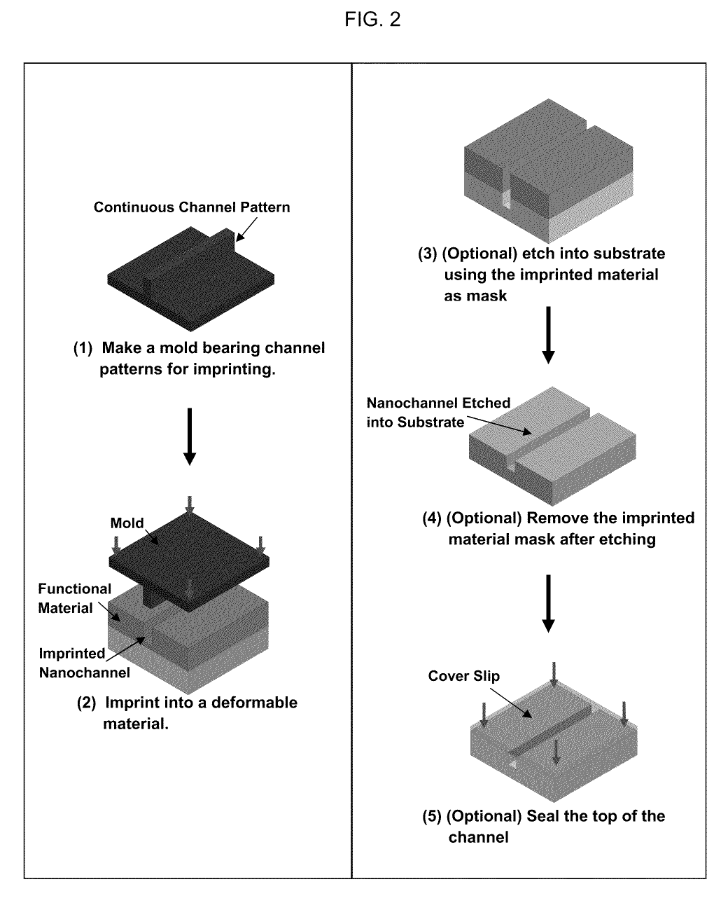

FIG. 2 illustrates embodiments of these steps. The novel method of fabricating and providing a nanoimprint mold which has nanochannel patterns that are narrow, long and continuous comprises (1) providing a mold substrate, (2) disposing on the mold substrate a layer of removable material; (3) forming on the layer of removable material an edge having a transverse wall (substantially perpendicular to the substrate surface) extending to the mold substrate surface, the edge and wall laterally extending (extending substantially parallel to the substrate surface) at least 50 micrometers or more and preferably at least 1 centimeter or more. A next step (4) is conformally depositing over the removable material, the edge and the wall, a thin layer of mold material that contacts and adheres (or coheres) to the mold substrate, the conforming layer having a thickness (or thinned to a thickness) of about 100 nanometers or is less. Step 5 involves removing portions of the conforming layer and the removable layer while retaining the portion of the conforming mold material deposited on the wall that adheres to the mold substrate. This is to leave a protruding portion of mold material that is adhered (or cohered) to the mold substrate and that has a width of less than 100 nanometers and a length 50 micrometers or more (and preferably one centimeter or more).

This method can advantageously be implemented by (1) selecting a crystal substrate with proper crystallographic orientation, (2) depositing a mask layer on the top of the crystal substrate, (3) patterning the mask layer on the crystal substrate with the pattern edge aligned to a crystalline plane, (4) anisotropically etching the surface of the crystal material using the patterned etching mask; (5) removing the etching mask, (6) conformally depositing the mold material, (7) anisotropically etching the mold material, (8) removing the crystal material, leaving a narrow sidewall defined by the conformal deposition, and (9) selectively removing parts and keeping the narrow sidewall (as the mold for nanochannels) as by using other lithography and patterning methods and integrating the kept parts with other parts that are needed for a device. The integration can be on the same mold.

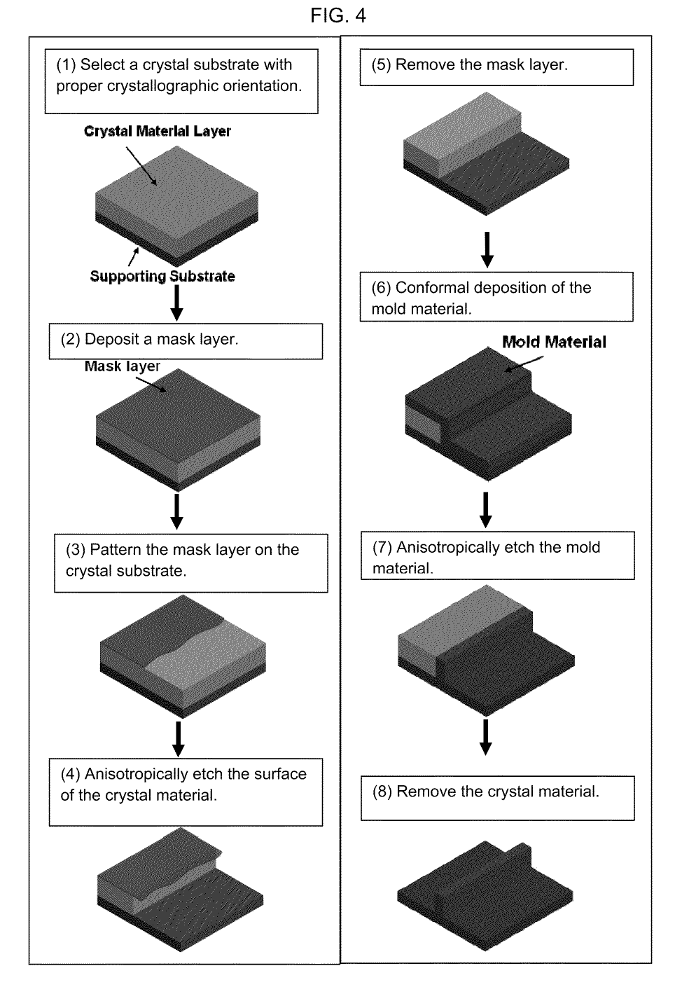

An example of the mold making is illustrated in FIG. 4. (1) (110)-oriented silicon-on-insulator (SOI) wafer is selected. (2) A thin layer of SiO₂ (˜10 nm) is grown on a (110)-oriented silicon-on-insulator (SOI) wafer by thermal oxidation; the SiO2 will be used as etching mask for later step. (3) Photolithography followed with RIE is performed to form the 0.5 cm×1.5 cm rectangle pattern in the SiO₂ layer. The longer edges of rectangles are aligned to {111} crystal planes. (4) The rectangle pattern is subsequently etched into (110) Si layer by anisotropic wet etching (KOH based), which can create a vertical and smooth sidewall at {111}, because the etching is in {110} is much faster than {111} planes. (5) The top SiO₂ mask layer is stripped away, and a vertical and smooth step in the Si layer is obtained. (6) Afterwards, SiₓN_{y} is deposited by low-pressure chemical vapor deposition (LPCVD) to conformably cover both sidewalls and top surfaces of (110) Si steps. (7) Anisotropic RIE is performed to etch away all SiₓN_{y} coated on horizontal surfaces, but SiₓN_{y} on the vertical sidewalls remains. (8) All (110) Si is selectively etched away, and the residual SiₓN_{y} on the box layer forms a protrusive channel line for imprinting. Herein, the nanochannel width is accurately determined by the LPCVD thickness, which can be as narrow as several nanometers and can also be continuous and uniform over a centimeter-long distance. And (9) using other lithography and patterning methods to selectively remove parts and keep the narrow sidewall as the mold for nanochannels and optionally integrating the kept parts with other parts that might be needed for a device on the same mold.

Once the imprint mold is obtained, it can be used to stamp concave nanochannels in various functional materials including UV or thermal curable polymers, rubber precursors, and other polymers. These imprinted nanochannels can be directly used for nanofluidic devices. Furthermore, the imprinted functional polymer films can be further functionalized for various applications.

Alternatively, the functional material layer bearing the imprinted nanochannel line can be used as the etching resist film for optional RIE transfer, which can subsequently etch with a high transfer fidelity long nanochannels in the underlying substrates which for example, can be semiconductors, metal or dielectrics like SiO₂, Si, or glass. The keys to achieve the high transfer fidelity and resolution are (1) a thin and uniform resist residual layer in the imprinted materials; (2) a high etching selectivity between the functional material (or resist) and the underlying substrate. The variation of the mold height over a centimeter-scale distance is in the order of tens of nanometers. In case of using the conventional polymer-based or viscous liquid resists, this variation will be retained in the resist residual layer thickness due to the poor flowability over centimeter-scale distance.

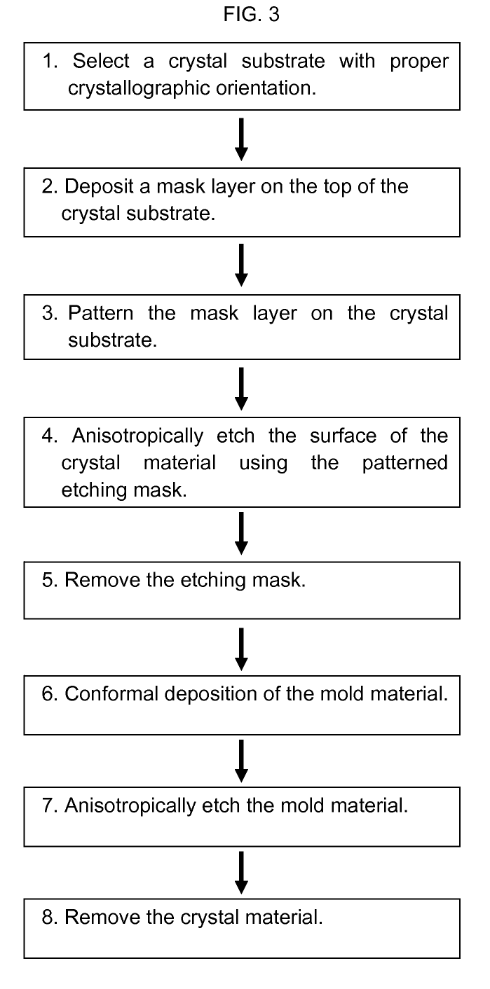

The scheme in FIG. 3 illustrates the imprint using a mold with a non-uniform height on a low-viscosity liquid resist film. The good flowability of the liquid can compensate the variation of residual layer thickness over a centimeter-scale distance.

Both the imprinted or etched nanochannels can be sealed with the cover slips to form enclosed nanofluidic channels. The long nanochannels can also be integrated with other device structures for more complicated applications

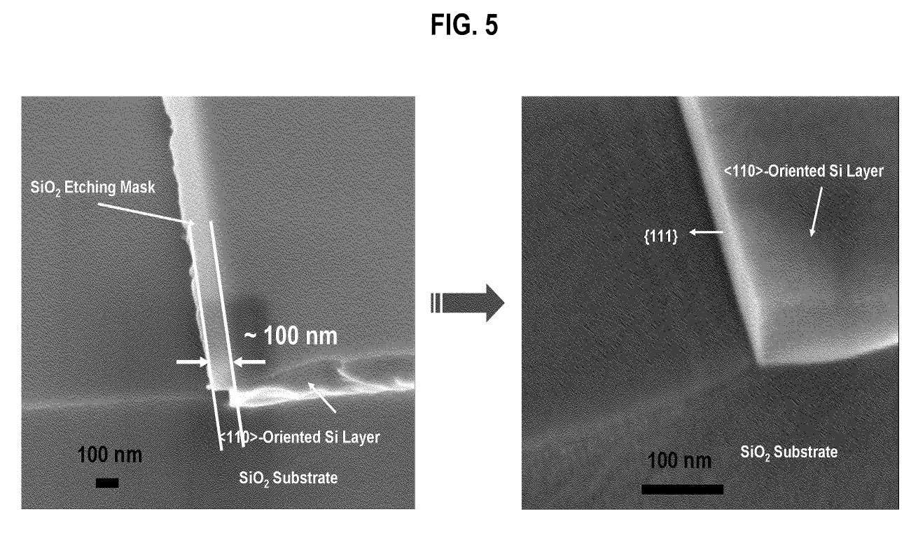

In the fabrication of an imprint mold bearing one or several long nanochannel patterns, we used a (110)-oriented silicon-on-insulator substrate. As the starting wafer for the mold fabrication, the SOI layer is preferably pre-thinned to a suitable thickness (typically tens of nanometers) for defining the mold height. The thinning process can be finished by alternating thermal oxidation and hydrofluoric (HF) acid etching. The SOI thickness can be monitored by an interferometer and the final variation of the SOI thickness can be controlled to be smaller than 15 nm over an at least 6 centimeter² area. A thin layer of SiO₂ or other accessible dielectric materials was deposited or grown on the top surface of the (110) SOI, which is subsequently patterned into large rectangles by any large-area lithographic techniques (photolithography or nanoimprint) followed with a brief etching (RIE or wet etching with buffered oxide etchant). During the lithography process, the longer edges of rectangles are intentionally aligned to {111} crystallographic axis. With the patterned rectangle layers as the etching masks, the (110) Si is etched by anisotropic wet etching. Because the crystalline silicon etching rate in the <111> direction is much slower than the etching rate in the <110> directions, this highly anisotropic chemical etching can create a vertical sidewall at {111} plane with atomic-scale smoothness regardless the edge roughness in the SiO₂ mask (see scanning electron microscopic (SEM) image in FIG. 5 (a)). After the etching mask layer was stripped away by a brief dip into selective etchant, a vertical and smooth step edge in (110)-oriented SOI was obtained (see the SEM image in FIG. 5 (b)). This smooth edge can be used as the template for forming the straight and continuous channel line at the edge. In addition, the vertical sidewall assures a vertical molding structure, which can effectively avoid the mechanical damage brought out by the asymmetrical molding force. The rest steps are about the edge formation of the channel line using this smooth edge as the template. The mold material such as SiO₂, SiNₓ, and other dielectric or semiconductor materials is conformally coated on the etched step edge in (110) Si by any conformal deposition methods (low-pressure chemical vapor deposition (LPCVD), plasma-assisted chemical vapor deposition (PECVD), thermal oxidation, and other physical deposition methods). Therefore, the mold material is coated everywhere including the vertical sidewalls and all horizontal surfaces. Afterwards, RIE is performed to etch away all mold material coated on the horizontal surfaces, the material on the vertical edge wall remains, because RIE is anisotropic. Finally, all (110) Si is selectively etched away, and the residual mold material remains to form the channel line.

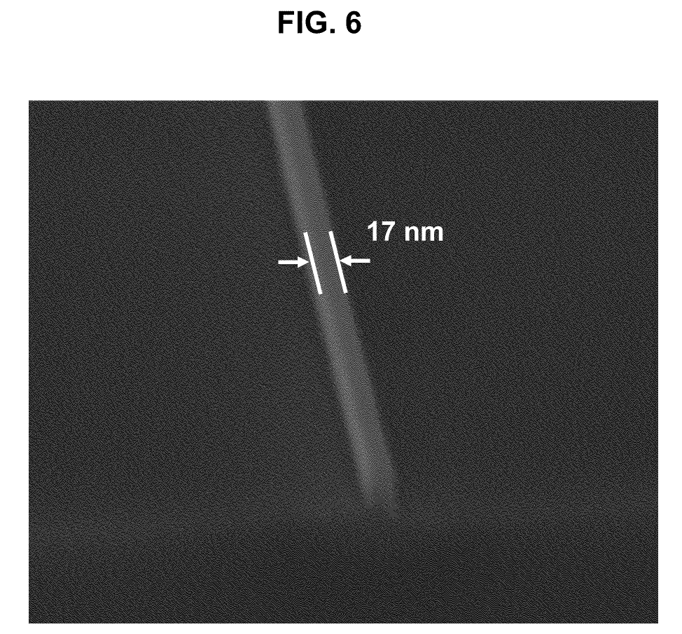

FIG. 6 (a) shows a cross-sectional SEM image of a typical imprint mold bearing a ˜17 nm wide 1.5 centimeter long protrusive nanochannel pattern. The smooth and vertical sidewalls of the mold are attributed to the nature of orientation-dependent wet chemical etching of (110) Si surface and conformal LPCVD of SiNₓ. More importantly, this fabrication route assures a continuous and uniform channel line over a centimeter-scale length even in case of any imperfection or roughness along the channel. This is an important feature for making working nanofluidic devices without any blockage. For example, the SEM image in FIG. 6 (b) indicates that even with a tiny step shift induced by the misalignment with the {111} crystallographic axis, the channel line width is still continuous and uniform.

Once the imprint mold is fabricated, it stamps out the single long nanochannels in various functional materials by nanoimprint lithography. For the imprint process, the functional materials could be thermal plastics, UV or thermal curable polymers, rubber precursors, or other polymers. The imprinted nanochannel in the functional material layer can be directly used for nanofluidic device. Alternatively, the surface of the functional material layer could be further chemically treated to achieve more functions. Further details concerning nanoimprint lithography can be found in U.S. Pat. No. 6,482,742 issued to Stephen Chou.

The long single channel structure in the functional material can also be used as an etching mask to faithfully transfer the patterns into underlying substrates such as silicon, glass, and fused silica. In order to achieve a high pattern transfer fidelity, the resist residual layer thickness is preferably uniform and thin, because it usually takes much longer time to etch away a excessively thick residual layer for exposing the underlying substrate surface. The longer etch time could lead to a significant lateral etching at the channel edge, therefore adding more error on the channel line. In addition, the etching selectivity between the functional material film and underlying substrate should be high enough to assure a high transfer fidelity.

As illustrated in FIG. 4, in order to achieve a thin and uniform residual layer thickness, a low-viscosity liquid resist is advantageously used for nanoimprint lithography. The resist can be either spin-coated or dispensed on the substrate. A low viscosity (0.5 cp to 2 cp) assures an excellent flowability of the resist during the imprint process. The resist flow driven by the non-uniformity of the imprinting pressure induced by the variation of the mold height over the centimeter-long distance can well compensate the non-uniformity of the resist thickness. Finally, the resist residual layer thickness can be made thinner than a few nanometers with a 3σ variation smaller than 5 nm.

The materials for making the substrate mold can be any crystal substrate including silicon, germanium, GaAs, InP or other crystal materials. The crystalline anisotropic etching can be by chemicals that etch faster in the normal direction of the wafer than in the lateral (parallel to wafer surface) direction. After making the mold, the mold can be repaired by various methods. The imprinted materials are all materials that can be deformed under the mold, including polymers and monomers that can be cured or modified by thermal heating, radiation or chemical reactions.

The patterning of the coated edges can be by a variety of methods including photolithography or imprinting. The mold substrates can be semiconductors, metals or dielectrics or their combinations or mixtures.

In addition to the narrow channels on the mold, other micro/nanostructures can be put on the mold for fluidic flow or for electrical and optical measurements.

The continuous hollow nanochannels described here have many biological, chemical, electronic, optical, magnetic and mechanical applications. One application is for the rapid detection and analysis of base-pairs of DNA strands. The DNA strands need to be linearized and confined in a nanometer-scale device space such as nanochannels. The nanochannel is one of most popular device structures for DNA analysis due to its unique advantages: (1) the nanochannel can completely confine and stretch the DNA strands, and hence significantly suppress the detection noise associated with DNA motion (swing, twisting, and translocation) and thermal fluctuation. (2) The nanochannel provides an environment in which the transport of biological species can be well controlled in an addressable way at the single molecule level. (3) The nanochannel can be easily integrated with other detection device units like nanowires, transistors, and optical waveguides.

Genomic DNA strands usually have a high-aspect-ratio (length L/width W) structure (the width of single-stranded and double-stranded DNAs is about 1 nm and 2 nm, respectively; the total contour length ranges from 100s micrometers to even centimeter-scale). Therefore, the nanochannel desirably has a similar aspect ratio, i.e. very narrow (sub-20 nm), but very long (from 50 micrometers to 1 centimeter or more) nanofluidic channels with continuous and uniform channel width. In addition, in order to realize the addressable control of the bio-species and lithography-compatible device integration, the fabrication method desirably has the ability to build well isolated long nanochannels.

It now can be seen that in one aspect the invention comprises a method of forming in a workpiece an open channel having a width of 100 nanometers or less and a much longer length comprising the steps of providing a mold having a molding surface with at least one protruding feature having a width of 100 nanometers or less and extending a length of 50 micrometers or more and preferably one centimeter or more. A workpiece is provided comprising a substrate having a moldable surface and the molding surface is imprinted into the moldable surface to form the open channel. The channel can be utilized in the layer of moldable material or transferred to the underlying substrate and optionally covered (in either case) by the application of an overlying surface layer.

As advantageous way to provide the mold is to provide a mold substrate comprising an etchable surface layer and mask a portion of the surface layer to define a mask edge extending to a length of one centimeter or more. A thin layer of anisotropically etchable mold material is then conformally deposited over the surface layer edge, the mold material having or thinned to a thickness of about 100 nanometers or less. The mold material is then anisotropically etched to selectively remove the mold material away from the surface layer edge, and the remainder of the surface layer is etched away to leave on the mold substrate a projecting feature having a width of 100 nanometers or less and a length on one centimeter or more.

1. A method of forming in a workpiece an open channel having a width of 100 nanometers or less and an open length of 50 micrometers or more and preferably one centimeter or more comprising the steps of:
providing an imprinting mold having a molding surface with at least one protruding linear feature having a width of 100 nanometers or less and extending a length of 50 micrometers or more and preferably one centimeter or more;
providing a workpiece comprising a substrate having a moldable surface; and
imprinting the molding surface into the moldable surface to imprint a pattern of the open channel.

2. The method of claim 1 further comprising the step of covering the pattern of the open channel to form a covered channel.

3. The method of claim 1 further comprising the step of etching the workpiece using the imprinted moldable surface as an etch mask.

4. The method of claim 1 wherein the moldable surface comprises a coating or layer on the substrate.

5. The method of claim 4 further comprising the step of etching the substrate using the imprinted coating or layer as an etch mask to form a pattern of the open channel in the substrate.

6. The method of claim 5 further comprising the step of covering the pattern of the open channel to form a covered channel.

7. The method of claim 4 further comprising the step of removing the imprinted coating or layer after etching the substrate.

8. The method of claim 7 further comprising the step of covering the pattern of the open channel in the substrate to form a covered channel.

9. The method of claim 1 wherein the workpiece comprises a substrate of a material selected from the group consisting of semiconductors, metals and dielectrics.

10. The method of claim 1 wherein the substrate comprises a moldable layer of a polymer material.

11. A device providing a nanoscale channel open for a flow of liquid, gas or their mixture comprising:
a workpiece having a surface and, formed in the surface, a channel having a width or diameter of less than 100 nanometers and a length in excess of 50 micrometers or more and preferably one centimeter or more, the channel open for the flow of liquid, gas or their mixture.

12. The device of claim 11 wherein the workpiece comprises a substrate having a surface coating or layer and the channel is imprinted into the surface coating or layer.

13. The device of claim 11 wherein the top of the channel is covered to form a covered channel.

14. The device of claim 11 wherein the workpiece comprises a substrate having a surface coating or layer and the channel is imprinted into the surface coating or layer and etched into the substrate surface.

15. The device of claim 14 wherein the top of the channel is covered to form a covered channel.

16. The device of claim 11 comprising a substrate having the channel etched into the substrate surface.

17. The device of claim 16 wherein the top of the channel is covered to form a covered channel.

18. The device of claim 11 wherein the workpiece comprises a material selected from the group consisting of semiconductors, metals and dielectrics.

19. The device of claim 12 wherein the surface coating or layer comprises a polymer material.

20. A method for making a mold to imprint a long nanoscale-width channel comprising the steps of:
providing a mold substrate comprising an etchable surface layer;
masking a portion of the surface layer to define a mask edge extending to a length of 50 micrometers or more and preferably one centimeter or more;
anisotropically etching away the unmasked portion of the surface layer leaving a stepped surface;
conformally depositing over the stepped surface a thin layer of anisotropically etchable mold material, the mold having or thinned to a thickness of about 100 nanometers or less;
anisotropically etching the mold material to selectively remove the mold material other than the protruding portion at the step; and
removing the remainder of the etchable surface layer, leaving the protruding portion of the mold material as a protruding linear region having a width of 100 nanometers or less and a length of 50 micrometers or more and preferably one centimeter or more.

21. The method of claim 20 wherein the etchable surface layer comprises an oriented crystalline layer.

22. The method of claim 20 wherein the etchable surface layer comprises oriented crystalline silicon.

23. The method of claim 20 wherein the mold substrate comprising an etchable surface layer comprises a silicon-on-insulator (SOI) wafer.

24. The method of claim 20 wherein the mold material comprises silicon nitride.

25. A mold for imprinting in a surface of deformable material a long open channel of nanoscale width comprising:
a substrate having a molding surface, the molding surface having at least one protruding linear feature having a width of 100 nanometers or less and extending a length of 50 micrometers or more and preferably one centimeter or more.

26. The mold of claim 25 wherein the substrate comprises a crystalline substrate.

27. The mold of claim 25 wherein the substrate comprises a material selected from the group consisting of semiconductors, metals and dielectrics.

28. The mold of claim 25 wherein the substrate comprises SiO₂, Si or glass.

29. The mold of claim 26 wherein the protruding linear feature comprises silicon nitride.

30. A method of making a mold for imprinting a long nanoscale width channel comprising the steps of:
a. providing a mold substrate;
b. disposing on the mold substrate a layer of removable material;
c. forming on said removable material an edge having a wall extending transversely to the mold substrate, the wall laterally extending at least 50 micrometers or more and preferably one centimeter or more;
d. conformally depositing over the edge and wall of the removable material a thin layer of mold material that contacts and adheres to the mold substrate, the thin layer having a thickness of 100 nanometers or less; and
e. removing at least portions of the mold material and the removable material while retaining portions of the mold material deposited on the wall and adhered to the mold substrate to produce a mold having a protruding linear region having a width of less than 100 nanometers and a length of 50 micrometers or more and preferably one centimeter or more.
